(19) United States
(12) Patent Application Publication
(10) Pub. No.: US 2026/0129439 A1
(43) Pub. Date: May 7, 2026

(54) IDENTITY VERIFICATION FOR CALL-BASED PROTECTED DATA TRANSMISSION OVER NETWORK

(71) Applicants: AT&T Intellectual Property I, L.P., Atlanta, GA (US); AT&T Mobility II LLC, Atlanta, GA (US)

(72) Inventors: Earl Berner, Allen, TX (US); John Tadlock, Sunnyvale, TX (US); Daniel Solero, Rockwall, TX (US)

(21) Appl. No.: 18/938,174

(22) Filed: Nov. 5, 2024

(51) Int. Cl. H04W 12/06; G10L 17/02; G10L 17/06; H04L 9/40

(52) U.S. Cl. CPC H04W 12/06; G10L 17/02; G10L 17/06; H04L 63/0861

(57) ABSTRACT

A processing system may connect, via a communication network, a call between an endpoint device of a user and an agent system associated with an individual. The processing system may next obtain a voice sample of the individual via the call and verify an identity of the individual, where the verifying comprises matching the voice sample of the individual to a voice signature of the individual. The processing system may then detect a disclosure of sensitive data by the user via the endpoint device, authorize the disclosure of the sensitive data via the endpoint device to the agent system, based upon the verifying of the identity of the individual via the matching of the voice sample of the individual to the voice signature of the individual, and transmit the sensitive data to the agent system, in response to the authorizing of the disclosure of the sensitive data.

The present disclosure relates generally to communication network-based call security, and more particularly to methods, computer-readable media, and apparatuses for transmitting sensitive data from a user endpoint device to an agent system during a call based upon a verification of an identity of an individual associated with the agent system via a matching of a voice sample of the individual obtained via the call to a voice signature of the individual.

### BACKGROUND

Various types of businesses provide customer service agents for handling a variety of customer-facing issues. For example, a communication network service provider may staff a call center with customer service agents for handling issues relating to billing, service disruption, adding and removing features from service plans, endpoint device troubleshooting, and so forth. In some cases, customers may contact the communication network service provider by a telephone call to the customer call center. In other cases, the communication network service provider may provide access to customer service agents via other communication channels, e.g., video calls or the like. Other entities may provide similar call centers where customers may interact with organization agents/representatives for a variety of issues. Often, these calls involve the disclosure of various types of sensitive data, such as account numbers, credit card numbers, and so forth.

### SUMMARY

In one example, the present disclosure provides a method, computer-readable medium and apparatus for transmitting sensitive data from a user endpoint device to an agent system during a call based upon a verification of an identity of an individual associated with the agent system via a matching of a voice sample of the individual obtained via the call to a voice signature of the individual. For example, a processing system including at least one processor may connect, via a communication network, a call between an endpoint device of a user and an agent system associated with an individual. The processing system may next obtain a voice sample of the individual via the call and verify an identity of the individual, where the verifying comprises matching the voice sample of the individual to a voice signature of the individual. The processing system may then detect a disclosure of sensitive data by the user via the endpoint device, authorize the disclosure of the sensitive data via the endpoint device to the agent system, based upon the verifying of the identity of the individual via the matching of the voice sample of the individual to the voice signature of the individual, and transmit the sensitive data to the agent system, in response to the authorizing of the disclosure of the sensitive data.

### BRIEF DESCRIPTION OF THE DRAWINGS

The present disclosure can be readily understood by considering the following detailed description in conjunction with the accompanying drawings, in which:

FIG. 1 illustrates one example of a system including a communication service provider network, according to the present disclosure;

FIG. 2 illustrates a flowchart of an example method for transmitting sensitive data from a user endpoint device to an agent system during a call based upon a verification of an identity of an individual associated with the agent system via a matching of a voice sample of the individual obtained via the call to a voice signature of the individual; and

FIG. 3 illustrates a high-level block diagram of a computing device specially programmed to perform the steps, functions, blocks and/or operations described herein.

To facilitate understanding, identical reference numerals have been used, where possible, to designate identical elements that are common to the figures.

### DETAILED DESCRIPTION

The present disclosure broadly discloses methods, non-transitory (i.e., tangible or physical) computer-readable media, and apparatuses for transmitting sensitive data from a user endpoint device to an agent system during a call based upon a verification of an identity of an individual associated with the agent system via a matching of a voice sample of the individual obtained via the call to a voice signature of the individual. For example, customers, e.g., subscribers, may contact a customer call center of a communication network for various issues relating to billing, service disruption, adding and removing features from service plans, endpoint device troubleshooting, and so forth. The customers may contact the customer call center via telephone, video call, or the like. Other entities may provide similar call centers where customers may interact with organization agents/representatives for a variety of issues. Often, these calls involve the disclosure of various types of sensitive data, such as account numbers, credit card numbers, and so forth. Existing techniques to prevent bad actors in this space include blocking calls from telephone numbers that are known to be sources of spam, fraud, etc., blocking connections to malicious internet protocol (IP) address, domains, etc. via antivirus software, firewall filtering, or the like, and so forth. However, despite these measures, in many cases users may provide information themselves, e.g., users may believe they are talking to their banks, doctor's offices, utility operators, or other service providers, when they may actually be interacting with bad actors pretending to be associated with such legitimate entities.

To address these and other risks, examples of the present disclosure include the use of voice signatures to add a level of trust to users'network-based calls/interactions that may include the release of sensitive/protected data. In particular, a network-based processing system and/or a user's endpoint device may store voice signatures of one or more individuals with whom the user may have ongoing interactions. For instance, a user may interact with a particular agent/representative of an organization on a regular or repeated basis (e.g., at least two or more calls or other interactions). As such, the endpoint device of the user, and/or a network-based processing system acting on behalf of the user, may be provided with a voice signature of the agent for use in subsequent calls with the agent in order to verify the agent's identity. In one example, an entity may make voice signatures of its authorized agents available to authorized users, e.g., after logging into an online account of the user associated with the entity, users can download to their endpoint devices and subsequently use the voice signatures to confirm they are interacting with authorized agents.

In one example, the voice signatures may comprise hash-based voice signatures that cannot be reverse engineered for use in machine learning-based generative voice impersonation. For example, to verify that a user is interacting with a valid agent, the user and agent may begin conversing during a call. Then, the user's endpoint device, and/or a network-based processing system acting on behalf of the user and situated in the call path, may extract a voice sample of the agent from the call data, apply a hash to the voice sample to generate a hashed voice sample, and apply the hashed voice sample to the hash-based voice signature. Upon determining a match between the hashed voice sample and the hash-based voice signature, the user's endpoint device and/or the network-based processing system may determine that the agent is verified (i.e., the speaker is the agent who the speaker purports to be). In one example, a notification may be presented via the user's endpoint device to indicate to the user that the agent identity has been verified. In accordance with the verification of the agent's identity, in one example, the user's endpoint device and/or the network-based processing system may detect a disclosure of sensitive/protected data from the user's endpoint device and may block or allow the transmission of the sensitive data to an agent device/system depending upon whether the agent identity is verified.

It should also be noted that examples of the present disclosure may incorporate and/or be used in conjunction with further data points and/or verification techniques. For instance, in one example, the present disclosure may scan a user's incoming calls to identify calls that appear to be from legitimate entities. To illustrate, a communication service provider network may maintain a list (or other database formats) of known phone numbers associated with an organization. Then, for a call directed to a user in which a caller identifier (ID) purports to be that organization, the present disclosure may verify that the phone number is in the list. If the source phone number is not in the list, the call may then be blocked, or the call may be permitted to ring through to the user's endpoint device (e.g., a smartphone or the like). However, an indicator may be presented to indicate that the source of the call is not verified and/or to indicate that the source of the call is suspicious due to the failure to match a phone number on the list. Alternatively, or in addition, the present disclosure may identify calls from source telephone numbers that are not in the user's address book/contact list, or from known organizations. These types of calls may then be further flagged for enhanced verification, e.g., via agent voice signature(s) in accordance with the present disclosure. For example, in real time, when an agent is unverified and a user is disclosing sensitive/private information (e.g., credit card number, social security number, account numbers, etc.), examples of the present disclosure may provide several actions: (1) provide visual and audible cues to the user that the other party (or parties) to a call is/are not verified and that the call may be a potential scam/fraud (behavioral nudge), (2) redact the private information from a call data stream (and in one example, inform the customer this has happened), and/or (3) provide options to the user to still allow the information to be sent to the agent on the other end (e.g., “press *3 to allow this information to be sent,” or the like). In one example, the present disclosure may further enable a user to configure the user's endpoint device and/or a network-based processing system acting on behalf of the user to generate and present summaries of calls listened to and the actions taken.

It should be noted that in accordance with the present disclosure, sensitive data may be disclosed by a user via keypad entries (e.g., dual-tone multi-frequency (DTMF) tones or the like) for a personal identification number (PIN), a passcode, a credit card number, an account number, a bank routing number, a social security number, or the like and/or via speech (e.g., spoken words, letters, numbers, etc.) for the same information and/or additionally for a name of the user, an address, a birthdate, a username, a password, etc. In one example, even where the disclosure of sensitive information is authorized, the present disclosure may nevertheless prevent the other party, e.g., an agent/representative of an organization, from hearing the sensitive information. For example, the present disclosure may extract and divert the sensitive information to an agent system that avoids an agent endpoint device. For instance, this may further protect the user from an agent being able to defraud the user, and may similarly protect the organization from potentially malicious agents harming the reputation of the organization.

To illustrate, this particular example may be useful where the user is asked to disclose sensitive information in order to verify the user's identity to the agent and/or an organization. For example, the user may be asked to verify the user's name, address, social security number, PIN, or the like. The user may be permitted to disclose this information, and such information may be transmitted to the organization upon a verification of the agent as described above. However, the agent does not personally need access to this sensitive information. Rather, the sensitive information may be permitted to be collected, may be compared to stored data associated with the user, and upon a successful match, the agent may be informed that the user has been verified. In this way, the organization/agent may verify the identity of the user, while the user may have additional assurance that the user is interacting with the party that the user intended to interact with.

In this regard, in one example, the present disclosure may also hash the sensitive information and transmit the sensitive information to the agent system in a hashed format. For instance, a user PIN may be transmitted in a hashed format, and may be compared to a stored hashed PIN at an agent/organization system. Thus, in one example, it may also be unnecessary for the sensitive information to ever be seen in connection with the call (e.g., either at the agent/organization system or in transit for all or a portion of the call path via one or more communication networks). Similarly, in one example, a user may enter credit card information, which may be permitted to be passed to a payment platform/system, where the agent may receive a notification that the credit card information was passed to such a system and was successfully charged. For instance, the notification may comprise a tone, automated speech, or the like presented to the agent (and/or to both the agent and the user) within the call, may comprise an indicator on a screen of an agent device of the agent or the like, and so forth.

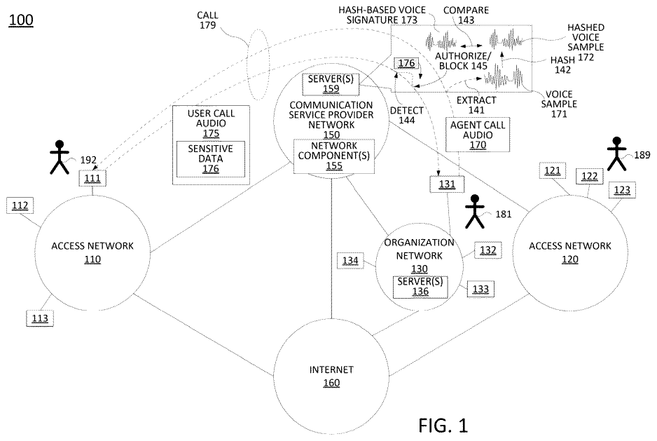

It should be noted that while examples of the present disclosure are described herein primarily in connection with voice telephone calls, the principles described herein are equally applicable to a variety of voice calls, e.g., public switched telephone network (PSTN) calls, voice over internet protocol (VoIP) calls, cellular telephone calls, etc., as well over the top (OTT) audio or video call services, audio/video conferences/meetings (such as Microsoft Teams meetings, Cisco Webex meetings, Skype meetings, Zoom meetings, etc.), and so forth. These and other aspects of the present disclosure are discussed in greater detail below in connection with the examples of FIGS. 1-3.

To aid in understanding the present disclosure, FIG. 1 illustrates an example system 100 comprising a plurality of different networks in which examples of the present disclosure may operate. Communication service provider network 150 may comprise a core network with components for telephone services, Internet services, and/or television services (e.g., triple-play services, etc.) that are provided to customers (broadly “subscribers”), and to peer networks. In one example, communication service provider network 150 may combine core network components of a cellular network with components of a triple-play service network. For example, communication service provider network 150 may functionally comprise a fixed mobile convergence (FMC) network, e.g., an IP Multimedia Subsystem (IMS) network. In addition, communication service provider network 150 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Communication service provider network 150 may also further comprise a broadcast video network, e.g., a traditional cable provider network or an Internet Protocol Television (IPTV) network, as well as an Internet Service Provider (ISP) network. With respect to video service provider functions (e.g., television service provider functions or the like), communication service provider network 150 may include one or more video servers for the delivery of video content, e.g., a broadcast server, a cable head-end, a video-on-demand (VoD) server, and so forth. For example, communication service provider network 150 may comprise a video super hub office, a video hub office and/or a service office/central office. For ease of illustration, various components of communication service provider network 150 are omitted from FIG. 1.

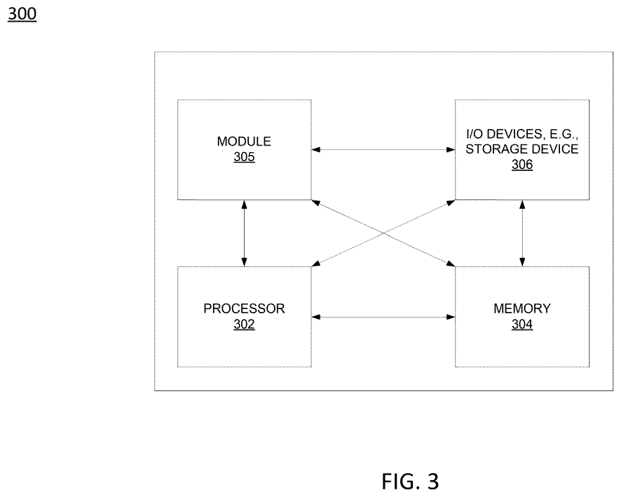

In one example, one or more network components 155, e.g., computing systems/servers, virtual network functions (VNFs) operating on shared hardware, etc. may provide the foregoing functions/services. In this regard, in one example, the network components 155 may each comprise a computing system, such as computing system 300 depicted in FIG. 3, and may be configured to host one or more network-based systems/components in accordance with the present disclosure. For example, a first system component may comprise a database of assigned telephone numbers, a second system component may comprise a database of basic customer account information for all or a portion of the customers/subscribers of the communication service provider network 150, a third system component may comprise a cellular network service home location register (HLR), e.g., with current serving base station information of various subscribers, and so forth. Other system components may include a Simple Network Management Protocol (SNMP) trap, or the like, a billing system, a customer relationship management (CRM) system, a trouble ticket system, an inventory system (IS), an ordering system, an enterprise reporting system (ERS), an account object (AO) database system, and so forth. In addition, other system components may include, for example, a layer 3 router, an SMS server and/or an MMS server, a voicemail server, a video-on-demand server, a server for network traffic analysis, and so forth. Still other system components may include cellular core network components, such as a serving gateway (SGW), an access management function (AMF), a mobility management entity (MME), a user plane function (UPF), a network slice selection function (NSSF), and so forth. It should be noted that in one example, a system component may be hosted on a single server, while in another example, a system component may be hosted on multiple servers, e.g., in a distributed manner. For ease of illustration, various components of communication service provider network 150 are omitted from FIG. 1.

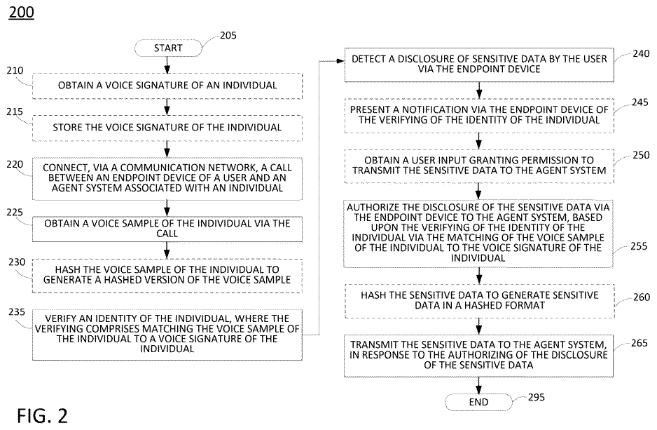

As further illustrated in FIG. 1, communication service provider network 150 may further include one or more server(s) 159. In accordance with the present disclosure, server(s) 159 may comprise one or more instances of a computing system, such as computing system 300 depicted in FIG. 3, and may individually or collectively be configured to perform various, steps, functions, and/or operations, for transmitting sensitive data from a user endpoint device to an agent system during a call based upon a verification of an identity of an individual associated with the agent system via a matching of a voice sample of the individual obtained via the call to a voice signature of the individual, such as illustrated in FIG. 2 and described in greater detail below. For instance, server(s) 159 may comprise a network-based voice authentication system in accordance with the present disclosure.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 3 and discussed below) or multiple computing devices collectively configured to perform various steps, functions, and/or operations in accordance with the present disclosure.

In one example, access networks 110 and 120 may each comprise a Digital Subscriber Line (DSL) network, a broadband cable access network, a Local Area Network (LAN), a cellular or wireless access network, and the like. For example, access networks 110 and 120 may transmit and receive communications between endpoint devices 111-113, 121-123, and communication service provider network 150 relating to voice telephone calls, communications with web servers via the Internet 160, organization network 130, and so forth. Access networks 110 and 120 may also transmit and receive communications between endpoint devices 111-113, 121-123 and other networks and devices via Internet 160. For example, one or both of access networks 110 and 120 may comprise an ISP network, such that endpoint devices 111-113 and/or 121-123 may communicate over the Internet 160, without involvement of communication service provider network 150.

Endpoint devices 111-113 and 121-123 may each comprise a telephone, e.g., for analog or digital telephony, a mobile device, a cellular smart phone, a laptop, a tablet computer, a desktop computer, a plurality or cluster of such devices, and the like. In one example, any one or more of endpoint devices 111-113 and 121-123 may further comprise software programs, logic, and/or instructions for video and/or multi-media calling/conferencing (e.g., online voice and/or video meetings), in addition to landline or cellular telephony or voice communications. In one example, any one or more of endpoint devices 111-113 and 121-123 may comprise a computing system, such as computing system 300 depicted in FIG. 3, and may be configured to perform various, steps, functions, and/or operations, for transmitting sensitive data from a user endpoint device to an agent system during a call based upon a verification of an identity of an individual associated with the agent system via a matching of a voice sample of the individual obtained via the call to a voice signature of the individual, such as illustrated in FIG. 2 and described in greater detail below.

In one example, the access networks 110 and 120 may be different types of access networks. In another example, the access networks 110 and 120 may be the same type of access network. In one example, one or more of the access networks 110 and 120 may be operated by the same or a different service provider from a service provider operating communication service provider network 150. For example, each of access networks 110 and 120 may comprise an Internet service provider (ISP) network, a cable access network, and so forth. In another example, each of access networks 110 and 120 may comprise a cellular access network, e.g., a radio access network (RAN) implementing such technologies as: global system for mobile communication (GSM), e.g., a base station subsystem (BSS), GSM enhanced data rates for global evolution (EDGE) radio access network (GERAN), a UMTS terrestrial radio access network (UTRAN) network, an evolved UTRAN (eUTRAN), a 5G RAN, an open RAN (O-RAN), etc., where communication service provider network 150 may provide mobile core network functions, e.g., of a public land mobile network (PLMN)-universal mobile telecommunications system (UMTS)/General Packet Radio Service (GPRS) core network, an evolved packet core (EPC), a 5G core (5GC), or the like. In still another example, access networks 110 and 120 may each comprise a home network, and office network, or the like, which may include a gateway, which receives data associated with different types of media, e.g., video, voice, and data/Internet, and separates these communications for the appropriate devices. For example, data communications, e.g., Internet Protocol (IP) based communications may be sent to and received from a router in one of the access networks 110 or 120, which receives data from and sends data to the endpoint devices 111-113 and 121-123, respectively. In this regard, it should be noted that in some examples, endpoint devices 111-113 and 121-123 may connect to access networks 110 and 120 via one or more intermediate devices, such as a gateway and router, e.g., where access networks 110 and 120 comprise cellular access networks, ISPs and the like, while in another example, endpoint devices 111-113 and 121-123 may connect directly to access networks 110 and 120, e.g., where access networks 110 and 120 may comprise local area networks (LANs) and/or home networks, and the like.

In one example, organization network 130 may comprise a local area network (LAN), or a distributed network connected through permanent virtual circuits (PVCs), virtual private networks (VPNs), and the like for providing data and voice communications. In one example, organization network 130 links one or more endpoint devices 131-134 with each other and with Internet 160, communication service provider network 150, devices accessible via such other networks, such as endpoint devices 111-113 and 121-123, and so forth. In one example, endpoint devices 131-134 may comprise devices of organizational agents, such as customer service agents, or other employees or representatives who are tasked with addressing customer-facing issues on behalf of the organization that provides organization network 130. In other words, in one example, organization network 130 may comprise a customer call center. In one example, endpoint devices 131-134 may each comprise a telephone for analog or digital telephony, a mobile device, a cellular smart phone, a laptop, a tablet computer, a desktop computer, a bank or cluster of such devices, and the like. In this regard, voice calls (and/or video or other types of calls) between customers and organizational agents may be facilitated via one or more of the communication service provider network 150 and Internet 160.

In one example, organization network 130 may be associated with the communication service provider network 150. For example, the organization may comprise the communication service provider, where the organization network 130 comprises devices and components to support customer service representatives, and other employees or agents performing customer-facing functions. For instance, endpoint devices 111-113 and 121-123 may comprise devices of customers, who may also be subscribers in this context. In one example, the customers may call or engage in telephone/audio, video, or other multi-media based calls via endpoint devices 111-113 and 121-123 with customer service representatives using endpoint devices 131-134. In one example, the organization network 130 may also include one or more servers 136. In one example, servers 136 may comprise one or more instances of a computing system, such as computing system 300 depicted in FIG. 3, and may be configured to perform operations in connection with examples of the present disclosure for transmitting sensitive data from a user endpoint device to an agent system during a call based upon a verification of an identity of an individual associated with the agent system via a matching of a voice sample of the individual obtained via the call to a voice signature of the individual.

For instance, in one example, calls involving endpoint devices 131-134 may be routed via server(s) 136. Alternatively, or in addition, server(s) 136 may comprise an agent platform that may establish separate and/or parallel communications with customer endpoint devices. For instance, server(s) 136 may receive sensitive data from customer endpoint devices in connection with calls between customer endpoint devices and agent devices (e.g., endpoint devices 131-134 in organization network 130). To further illustrate, server(s) 136 may comprise a payment platform, or may operate as a payment terminal/node in a distributed payment system. Thus, server(s) 136 may be configured to receive credit card information, bank account information, user account information, or the like, and to initiate payments between the user and the organization (or between the user and one or more other entities via organization, such as where the organization network 130 is itself operated by a bank, a credit card provider, or the like) via one or more payment networks, e.g., a credit card payment network, a Society for Worldwide Interbank Financial Telecommunication (SWIFT) network, etc. In another example, server(s) 136 may alternatively or additionally comprise an account management system, an account database system, or the like. For example, server(s) 136 may store customer account information, including account holder names, addresses, credit card information, PINs, passcodes, passwords, usernames, payment history information, subscription information, network usage information, and so forth. In one example, server(s) 136 may receive sensitive data from customer endpoint devices and may compare the sensitive data to stored records for user/customer identity verification and/or account access security. Thus, for example, server(s) 136 may allow calls between endpoint devices 131-134 and customer endpoint devices to proceed when the users/customers are verified, may provide indications to endpoint devices 131-134 of successful user/customer authentications, successful payments, and so forth.

In one example, server(s) 136 may publish voice signatures of different agents that may represent the organization (and/or the time of day that the agents may be on duty for the organization), and who may engage in calls with customers/users, e.g., via endpoint devices 131-134. For example, users via endpoint device 111-113 or the like may initiate web-based/online sessions with server(s) 136, may provide login credentials to access their respective accounts, and may download agent signatures for subsequent use in verifying agents'identities during calls with the organization. In one example, server(s) 136 may further collect call records for calls to the organization network 130, e.g., customer service calls. For instance, one or more of the servers 136 may comprise a call management system integrating interactive voice response (IVR) functionality with automatic call distribution, call logging, call record creation and tagging, and so forth. Such a call management system may generate customer service call records which store data regarding which one of the endpoint devices 131-134 initiated an outgoing call and/or which customer service agent was assigned an incoming call, a duration of the call, an indication of whether the issue the customer called about was resolved during the call, a reason code for the call, whether sensitive data was entered/provided by a customer during a call, the type of sensitive data, whether a user was authenticated, whether a payment was processed, whether the payment processing was successful, etc. In still other examples, server(s) 136 may provide various additional functions in connection with communication network operations and/or call center operations a described herein.

In an illustrative example, a customer, e.g., user 192 may engage in a call via endpoint device 111 with an agent 181, e.g., at endpoint device 131. The call may be initiated via either of endpoint device 111 or endpoint device 132. In one example, the endpoint device 111 may have previously obtained a voice signature of an agent, e.g., agent 181. For instance, the user 192 may have access the user's account with the organization via server(s) 136 and downloaded the agent's voice signature to endpoint device 111. Alternatively, or in addition, the agent 181 may have previously provided the agent's voice signature, e.g., via endpoint device 131 (or other endpoint devices) in a prior call with user 192 via endpoint device 111. As noted above, the agent's voice signature may comprise a hashed voice signature, e.g., hash-based voice signature 173. In one example, the hash-based voice signature 173 may be provided to server(s) 159, e.g., operating on behalf of user 192 and/or endpoint device 111 as a network-based service for agent identity verification. Alternatively, or in addition, the organization, e.g., via server(s) 136/organization network 130 may provide the hash-based voice signature 173 to server(s) 159 for public use. For instance, at the commencement of the call 179, the agent 181 may provide the agent's name or another identifier (e.g., an agent ID) to the user 192.

In one example, the voice signature may comprise a speech or other audio detection models, which may be trained from extracted audio features from one or more representative audio samples of the agent 181, such as low-level audio features, including: spectral centroid, spectral roll-off, signal energy, mel-frequency cepstrum coefficients (MFCCs), linear predictor coefficients (LPC), line spectral frequency (LSF) coefficients, loudness coefficients, sharpness of loudness coefficients, spread of loudness coefficients, octave band signal intensities, and so forth, wherein the output of the model in response to a given input set of audio features is a prediction of whether a voice of the agent 181 is or is not present.

In one example, a voice signature, e.g., a detection model, may be in accordance with one or more machine learning algorithms (MLAs), e.g., one or more trained machine learning models (MLMs). For instance, a machine learning algorithm (MLA), or machine learning model (MLM) trained via a MLA may be for detecting whether speech of a particular individual (e.g., agent 181) is or is not present in an audio sample. For instance, the MLA (or the trained MLM) may comprise a deep learning neural network, or deep neural network (DNN), such as convolutional neural network (CNN), a generative adversarial network (GAN), a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on.

In one example, the voice signature may comprise a hash-based voice signature, e.g., hash-based voice signature 173. For instance, an MLA/MLM-based voice signature may be trained in accordance with hashed audio training data comprising hashed speech of the agent 181. Thus, for detection/classification via such a model, the expected input(s) may also comprise a hashed audio sample, or samples. Alternatively, or in addition, the voice signature may comprise a vector in a feature space having multiple dimensions corresponding to the various audio feature types as noted above (and/or a lesser set of dimensions generated via principal component analysis (PCA) or other transform functions). In one example, such a vector may be hashed via a hash function/algorithm to comprise hash-based voice signature 173. In one example, a public hash algorithm/function may be provided along with the hash-based voice signature 173, e.g., where the hashing algorithm is the same as was used in connection with hashing of the model training data or the hashing of the vector (where “public” means that the hashing algorithm/function may be provided to one or more endpoint devices or other processing systems external to the organization network 130).

In one example, the call 179 may automatically be established via server(s) 159. In other words, server(s) 159 may be in the call path (e.g., for both user data (e.g., voice, video, or other user data) and call signaling/management data). In another example, user 192 may provide an input via endpoint device 111 which may cause endpoint device 111 to request that server(s) 159 be included in the call path for call monitoring on behalf of the user 192. In one example, endpoint device 111 may provide the hash-based voice signature 173 to server(s) 159 in connection with such as request. However, in another example, server(s) 159 may have previously stored the hash-based voice signature 173 on behalf of the user 192, and/or on behalf of the organization. In any case, the call 179 may be established between endpoint device 111 and endpoint device 131. In one example, server(s) 159 are in the call path of the call 179. In addition, in one example, server(s) 136 may also be in the call path of the call 179. However, in another example, server(s) 136 may not be in the call path of the call 179, but may establish a separate communication with endpoint device 111 and/or with endpoint device 131 on an as-needed basis (e.g., to authenticate user 192, to accept payment or other account information, etc.). In one example, an “agent system” may collectively include one or more of endpoint devices 131-134 and the server(s) 136.

During the call, the agent 181 may generate agent call audio 170. For instance, the agent 181 may engage in initial conversation with the user to exchange pleasantries, to ask for and receive information and/or to provide information as to the purpose of the call 179, etc. In one example, from a sufficient sample of the agent call audio 170 server(s) 159 may then extract (141) a voice sample 171 from the agent call audio 170. For instance, the voice sample 171 may comprise audio features identified in the agent call audio 170, such as the types of audio features noted above, e.g., low-level audio features, including:
spectral centroid, spectral roll-off, signal energy, mel-frequency cepstrum coefficients (MFCCs), linear predictor coefficients (LPC), line spectral frequency (LSF) coefficients, loudness coefficients, sharpness of loudness coefficients, spread of loudness coefficients, octave band signal intensities, and so forth. In one example, server(s) 159 may next hash (142) the voice sample 171 to generate a hashed voice sample 172. For instance, server(s) 159 may be provided with a public hash algorithm/function to use in connection with the hash-based voice signature 173.

In one example, server(s) 159 may then compare (143) the hashed voice sample 172 to the hash-based voice signature 173. For instance, in one example, the comparing at 143 may include determining a distance between a vector representing the hashed voice sample 172 and the hash-based voice signature 173 within a feature/vector space. For example, the distance may comprise a Euclidean distance, a Manhattan distance, a cosine distance, etc. In one example, the distance may comprise a confidence score, or a confidence score may be based on the distance, e.g., linearly proportional or otherwise. For instance, distances below (or equal to) a threshold may be considered a positive match between the hashed voice sample 172 and the hash-based voice signature 173 (e.g., indicating detection of a voice of agent 181), while distances above the threshold may be considered to be a negative match (e.g., a voice of a different individual who is not agent 181), where the distance below the threshold may relate to the confidence of the positive match/verification, while the distance above the threshold may be relate to a confidence of the negative match. In another example, the comparing of step 143 may comprise applying the hashed voice sample 172 as an input to a detection model comprising the hash-based voice signature 173 and obtaining an output of the detection model, e.g., indicating whether there is a positive or negative match, and/or a confidence score of the respective output. In one example, upon the outcome of the comparing (143), server(s) 159 may transmit a notification to the endpoint device 111, e.g., for presentation to the user 192. For instance, the notification may be presented via a display screen of endpoint device 111, may be presented in an audible format via a headphone or speaker, or the like. In one example, the notification may be inserted into an audio stream for the call 179, e.g., to be audible to user 192 at endpoint device 111, and/or to be audible to both user 192 and agent 181 via endpoint devices 111 and 131, respectively.

During the call 179, the user 192 may also have a stream of user call audio 175 being transmitted from endpoint device 111 to endpoint device 131, e.g., via access network 110, communication service provider network 150 and server(s) 159, and organization network 130 (in one example, server(s) 136 may also be in the path of call 179). Continuing with the present example, at some point during the call 179, the user 192 may disclose, or attempt to disclose sensitive information. For instance, the user call audio 175 may include sensitive data 176. In one example, server(s) 159 may detect (144) the disclosure/attempted disclosure of sensitive data 176. To further illustrate, server(s) 159 may detect the disclosure/attempted disclosure of sensitive data 176 in several ways. For example, server(s) 159 may include a speech-to-text module that may process the incoming user call audio 175, e.g., extracting features, such as those described above or others, and applying the extracted features to a decoder, e.g., a machine learning model (e.g., a hidden Markov model (HMM), a language model (e.g., a large language model (LLM)), a small vocabulary language model, or the like) to identify phonemes, and ultimately spoken characters (e.g., letters or ordinal numbers), words (e.g., including multi-digit numbers), phrases, and so forth. In one example, the output text may be processed to detect specific keywords, phrases, or other utterances that are indicative of impending disclosure of sensitive information (e.g., sensitive data 176 in the present example). For instance, in one example, server(s) 159 may be configured to find specific phrases such as: “my credit card number is . . . ,” “the credit card number is . . . ,” “the password is . . . ,” “the pin is . . . ,” “expiration date is . . . ,” “name on card . . . ,” “my name is . . . ,” “my bank account number is . . . ,” “my address is . . . ,” “my home address is . . . ,” “are you ready for my account number? . . . ,” and so forth. For instance, server(s) 159 may maintain a list of phrases that are indicative of an imminent disclosure of sensitive data (e.g., sensitive data 176). In one example, server(s) 159 may also scan for variants of such phrases in the transcribed audio/text. In one example, server(s) 159 may alternatively or additionally detect sensitive data in the middle of being disclosed. For instance, while certain key phrases may be missed, or the user 192 may omit speaking such phrases, server(s) 159 may alternatively or additionally detect a sequence of ordinal numbers and may cut-off a transmission of further user call audio 175 (e.g., at least a portion of the sensitive data 176). For example, user 192 may articulate the sequence of “seven, three, two, seven, six, seven, . . . ” before server(s) 159 may be able to cut-off the last four digits of a telephone number from immediate transmission to endpoint device 131.

Alternatively, or in addition, server(s) 159 may implement one or more additional detection models (e.g., one or more MLMs/trained MLAs, which may be trained by server(s) 159, or which may be trained separately by communication service provider network 150 and which may be deployed for operation within/by server(s) 159). For instance, an MLM implemented by server(s) 159 may be trained to detect speech indicative of disclosure of sensitive data. For example, training data may comprise a corpus of labeled text samples, e.g., that are labeled with label values such as “sensitive data disclosure” or “no sensitive data disclosure” (e.g., positive and negative examples), or more specific labels, such as “credit card information disclosure,” “address disclosure,” “PIN disclosure,” “account number disclosure,” etc. A trained MLM may then be deployed by server(s) 159 that is configured (i.e., trained) to process new text input data (e.g., in real time/streaming) to detect imminent sensitive data disclosure (in general, and/or of one or more specific types).

In one example, server(s) 159 may generate an immediate alert (e.g., as fast as practicable given the processing capabilities of server(s) 159, network traffic and competition for resources, etc.) to user 192 via endpoint device 111 of the detection of imminent disclosure of sensitive data (e.g., sensitive data 176). Thus, in one example, user 192 may choose to proceed (or not) in response to the alert. As noted above, in one example, endpoint device 111 may also present to user 192 a notification of whether the agent 181 is authenticated or not. In one example, the notification of authentication of agent 181 may be presented as the authentication is completed (e.g., as soon as practicable after determination by server(s) 159), or may be presented upon detection of the disclosure/attempted disclosure of the sensitive data 176. In still another example, the user 192 may continue to speak the sensitive data 176, e.g., without delay, interruption, and/or pause following one or more words, phrases, etc. indicative of the upcoming disclosure of sensitive data 176. In other words, server(s) 159 may not intervene to prevent user 192 from speaking or entering the sensitive data 176 (e.g., via a dial pad, a keypad, or the like).

In an example in which server(s) 159 previously authenticated agent 181, at 145 the server(s) 159 may take no action on the user call audio 175, e.g., the sensitive data 176 may be allowed to pass without diversion via server(s) 159 (e.g., illustrated as “authorized” at 145 in FIG. 1). In another example, server(s) 159 may be configured to buffer the portion of the user call audio 175 following the detection of the disclosure/attempted disclosure of the sensitive data 176, regardless of the authentication status of agent 181. In other words, server(s) 159 may capture the sensitive data 176 for temporary hold. In such an example, server(s) 159 may wait for the release of the sensitive data based upon a specific input received from user 192. For example, server(s) 159 may insert a communication in the audio stream of call 179 to endpoint device 111 to prompt the user 192 (e.g., “press or say ‘1’ to release the sensitive data,” or the like). In one example, the prompt may include (for the first time, or as a reminder) the authentication status of the agent 181. For instance, an example prompt may be “press or say ‘1’ to release the sensitive data—network operator has verified remote party identity via voice signature,” or the like. Alternatively, or in addition, user 192 may be accustomed to the use of the voice authentication service of server(s) 159 and may have a user profile such that server(s) 159 may simply provide a particular tone indicating sensitive data disclosure has been detected and that the remote party has been authenticated (or a second tone indicating sensitive data disclosure being detected and the remote party is not authenticated), whereupon the user 192 may know from experience to press 1 or 2 to release or permanently block the sensitive data 176 from being transmitted, e.g., to endpoint device 131. In still another example, server(s) 159 may be configured to automatically block (e.g., illustrated at 145 in FIG. 1) transmission of sensitive data 176 upon a failure of authentication of agent 181 (e.g., with notice to user 192 via endpoint device 111 of the detection and the blocking/dropping action taken). In various examples, different users may have their respective preferences implemented by server(s) 159 as to whether to automatically block or forward/authorize sensitive data depending upon the success or failure of authentication of the remote party, depending on the type of sensitive data that may be detected, and so forth.

In one example, server(s) 159 may log information relating to call 179 in the event of a failure of agent 181 to authenticate and/or following a blocking of sensitive data 176. For instance, a telephone number of endpoint device 131, an IP address of endpoint device 131, a conference username/handle associated with endpoint device 131, and so forth may be logged as suspect. This data may be additionally shared with other systems of communication service provider network 150, such as a fraud detection platform, a spam detection platform, and so forth. In the event that the sensitive data 176 is allowed to pass, in one example, server(s) 159 may simply allow user call audio 175 to stream uninterrupted. In another example, the sensitive data 176 may be transmitted with some delay and may be preceded by an announcement that sensitive data is being delivered with a delay. In one example, both parties may be accustomed to the operations of server(s) 159 and may simply know to pause for a few moments to wait for the confirmation.

In one example, the sensitive data 176 may not be transmitted to endpoint device 131, but may be extracted by server(s) 136 (which in one example may be present in the call path of call 179). In another example, server(s) 136 may establish a separate communication path/call with server(s) 159 and/or endpoint device 111 to obtain the sensitive data 176. In other words, the sensitive data 176 may be diverted to server(s) 136 and not to endpoint device 131. For instance, as noted above, in many scenarios it is not necessary for agent 181 to have personal access to users'sensitive/personal information (e.g., sensitive data 176, etc.). For example, this may itself be an additional risk vector for fraud, theft, or the like. Instead, credit card information, account information, or other payment information may be handled by an automated system such as server(s) 136 as discussed above. Similarly, user 192 may be providing a PIN for purposes of authenticating the identity of user 192 to the organization network 130. However, it may be unnecessary for agent 181 to manually receive and verify the PIN. Rather, the PIN can be received at server(s) 136, compared to a stored PIN (e.g., a hash thereof), and upon successful confirmation, server(s) 136 may provide a notification to agent 181 via endpoint device 131.

It should be noted that the foregoing describes just several examples, of detecting and processing sensitive data from a user endpoint device to an agent system during a call and that other, further, and different examples of the present disclosure may involve variations of the above. For instance, in another example, a bad actor 189 may initiate a call via endpoint device 122 to user 192 at endpoint device 111 and may purport to be a representative of an organization associated with organization network 130. However, various pieces of information may be used by communication service provider network 150 on behalf of user 192 to detect that the call may be malicious or fraudulent. For instance, the calling telephone number, IP address, or the like may not be a known number, IP address, etc. associated with organization network 130. Alternatively, or in addition, in one example, bad actor 189 may fail to provide a voice signature for use in authentication, or may fail to identify themselves such that a voice signature could be retrieved from a repository where voice signatures are available (e.g., server(s) 136, or the like). Further still, the bad actor 189 may provide a false name or agent ID, such that server(s) 159 may capture a voice sample of the bad actor 189, apply a voice signature associated with the name/agent ID to the voice sample, and determine a failure of the voice sample to match. Thus, user 192 may be alerted and the call terminated and/or the user 192 prevented from disclosing sensitive data.

In still another example, some or all of the operations/functions described above with respect to server(s) 159 may alternatively or additionally be performed by endpoint device 111. For instance, endpoint device 111 may scan user call audio 175 to detect disclosure of sensitive data 176 and may block, allow, or temporarily hold/buffer sensitive data 176 depending upon whether endpoint device 111 has received a notification of successful authentication of agent 181, depending upon the type of sensitive data, depending upon preferences of user 192, etc. In one example, endpoint device 111 may alternatively or additionally possess hash-based voice signature 173 of the agent 181 and may perform the functions of 141-145, e.g., extracting voice sample 171, hashing the voice sample to generate hashed voice sample 172, comparing the hashed voice sample 172 to the hash-based voice signature 173, detecting a disclosure of sensitive data 176, and blocking or allowing the transmission of the sensitive data 176 depending upon the result of the comparison (e.g., whether or not agent 181 is authenticated).

As noted above, in still another example, the present disclosure may also apply to video and/or multimedia calls. To further illustrate, for video and/or multimedia-based calls, an agent signature/detection model may be further trained/configured to utilize visual features for generating a quantized vector representing a facial identifier (ID), or similarly used to train a MLM-based detection model. For instance, such visual features may include low-level invariant image data, such as colors (e.g., RGB (red-green-blue) or CYM (cyan-yellow-magenta) raw data (luminance values) from a CCD/photo-sensor array), shapes, color moments, color histograms, edge distribution histograms, etc. Visual features may also relate to movement in a video and may include changes within images and between images in a sequence (e.g., video frames or a sequence of still image shots), such as color histogram differences or a change in color distribution, edge change ratios, standard deviation of pixel intensities, contrast, average brightness, and the like. In one example, the MLA/MLM (e.g., the agent signature/detection model) may comprise or may include a scale-invariant feature transform (SIFT) model a Speeded Up Robust Features (SURF)-based algorithm, a cosine-matrix distance-based detector, a Laplacian-based detector, a Hessian matrix-based detector, a fast Hessian detector, an eigenface-based detector, etc. In one example, a verification of an identity of agent 181 may be in accordance with a plurality of detection models/signatures, e.g., a voice signature as well as a facial recognition model, e.g., an eigenface, a SIFT or SURF model, or the like. For instance, server(s) 159 may verify the agent identity when the multiple models indicate that the agent 181 is on the call 179, when a composite score based on a weight sum of confidence scores output by the respective models exceeding a threshold, and so forth.

These and other example operations for transmitting sensitive data from a user endpoint device to an agent system during a call based upon a verification of an identity of an individual associated with the agent system via a matching of a voice sample of the individual obtained via the call to a voice signature of the individual are described in greater detail below in connection with the example of FIG. 2. In addition, it should be realized that the system 100 may be implemented in a different form than that illustrated in FIG. 1, or may be expanded by including additional endpoint devices, access networks, network elements, application servers, etc. without altering the scope of the present disclosure.

FIG. 2 illustrates an example flowchart of a method 200 for transmitting sensitive data from a user endpoint device to an agent system during a call based upon a verification of an identity of an individual associated with the agent system via a matching of a voice sample of the individual obtained via the call to a voice signature of the individual. In one example, the steps, operations, or functions of the method 200 may be performed by any one or more of the components of the system 100 depicted in FIG. 1. For instance, in one example, the method 200 may be performed by one of server(s) 159 or a user's endpoint device, such as endpoint device 111, or by server(s) 159 or endpoint device 111 in conjunction with one another and/or other components of the system 100, such as server(s) 136, another endpoint device, e.g., endpoint device 131 or the like, and so forth. In one example, the steps, functions, or operations of method 200 may be performed by a computing device or system 300, and/or processor 302 as described in connection with FIG. 3 below. For instance, the computing device or system 300 may represent any one or more components of server(s) 159, endpoint device 111, etc. in FIG. 1 that is/are configured to perform the steps, functions and/or operations of the method 200. Similarly, in one example, the steps, functions, or operations of method 200 may be performed by a processing system comprising one or more computing devices collectively configured to perform various steps, functions, and/or operations of the method 200. For instance, multiple instances of the computing device or processing system 300 may collectively function as a processing system. For illustrative purposes, the method 200 is described in greater detail below in connection with an example performed by a processing system.

The method 200 begins at step 205 and may proceed to optional step 210 or to step 220. At optional step 210, the processing system may obtain a voice signature of an individual. For instance, the individual may be an agent representing an organization to which a user may disclose sensitive data. However, in another example, the individual may be another person to whom the user may disclose sensitive data, such as a sole proprietor of small business, or the like. The voice signature may be provided to the processing system from an agent system associated with the individual (e.g., an endpoint device of the individual, a web server of an organization of the individual, or the like). In one example, the voice signature may be provided during or in connection with a prior call between the user and the individual. In another example, the user, via the user's endpoint device may access and download the voice signature, e.g., from a web server or the like. In one example, the individual may provide a uniform resource locator (URL) or the like to the user to enable the user to access a network-based repository from which the voice signature may be obtained. In one example, the processing system may comprise and/or may be a component of the user's endpoint device. In another example, the processing system may comprise one or more network-based servers. In such case, step 210 may include the processing system accessing/obtaining multiple voice signatures, e.g., for a number of agents representing an organization.

As noted above, the voice signature may comprise a speech or other audio detection models, which may be trained from extracted audio features from one or more representative audio samples of the individual. For instance, in one example, the voice signature may comprise a vector in a feature space having multiple dimensions corresponding to the various audio feature types as noted above (and/or a lesser set of dimensions generated via principal component analysis (PCA) or other transform function). In another example, the voice signature may comprise a machine learning model (MLM) that is trained/configured to detect whether speech indicative of the individual is present in a given audio sample. In one example, the voice signature may comprise a hash-based voice signature. For instance, an MLA/MLM-based voice signature may be trained in accordance with hashed audio training data comprising hashed speech of the individual. Thus, for detection/classification via such a model, the expected input(s) may also comprise a hashed audio sample, or samples. In another example, the hash-based voice signature may comprise a hash of a feature vector as described above. In one example, a public hash algorithm/function may be provided along with the hash-based voice signature, e.g., where the hashing algorithm is the same as was used in connection with hashing of the model training data and/or the feature vector comprising the voice signature.

At optional step 215, the processing system may store the voice signature of the individual, e.g., in an internal storage system or external storage system (e.g., a cloud-based storage system, an external drive, etc.) that is accessible to the processing system.

At step 220, the processing system connects, via a communication network, a call between the endpoint device of the user and the agent system associated with the individual. For instance, as noted above, in one example, the processing system may comprise the endpoint device of the user. In another example, the processing system may comprise one or more network-based servers. In such an example, the processing system may include itself in a call path via the communication network between the endpoint device of the user and the agent system associated with the individual. In various examples, the call may comprise a voice telephone call, e.g., a PSTN call, a VoIP call, a cellular telephone call (e.g., where at least one of the parties is using a cellular endpoint device), etc., an OTT audio or video call, an audio/video conference/meeting, and so forth.

At step 225, the processing system obtains a voice sample of the individual via the call. For instance, step 225 may include extracting audio features from a data stream of the call (e.g., an audio stream, or a combined media stream that includes at least audio data) as described above, such as extracting low-level audio features, including: spectral centroid, spectral roll-off, signal energy, mel-frequency cepstrum coefficients (MFCCs), linear predictor coefficients (LPC), line spectral frequency (LSF) coefficients, loudness coefficients, sharpness of loudness coefficients, spread of loudness coefficients, octave band signal intensities, and so forth.

At optional step 230, the processing system may hash the voice sample of the individual to generate the hashed version of the voice sample. For instance, in one example, the hashing may utilize the same hash function/hashing algorithm as used to hash the voice signature, or as used for hashing the training data of an MLM comprising the voice signature. For example, such hash function/algorithm may be obtained along with the voice signature at optional step 210 (e.g., and stored along with the voice signature at step 215).

At step 235, the processing system verifies an identity of the individual, where the verifying comprises matching the voice sample of the individual to the voice signature of the individual. For instance, the voice signature of the individual may be obtained via a prior network-based communication between the endpoint device of the user and the agent system, e.g., at optional step 210, or otherwise. In one example, step 235 may comprise matching the hashed version of the voice sample of the individual (e.g., generated at optional step 230) to a hash-based voice signature of the individual. For instance, the voice signature of the individual, as received, may be hashed, or may comprise an MLM that has been trained on hashed audio training data. To further illustrate, step 235 may include determining a distance between vectors representing the hashed voice sample and the hash-based voice signature within a feature/vector space. For example, the distance may comprise a Euclidean distance, a Manhattan distance, a cosine distance, etc. In one example, the distance may comprise a confidence score, or a confidence score may be based on the distance, e.g., linearly proportional or otherwise. In another example, step 235 may include applying the hashed voice sample as an input to a detection model (e.g., an MLM) comprising the hash-based voice signature, and obtaining an output of the detection model, e.g., indicating whether there is a positive or negative match and/or a confidence score of the respective output.

In one example, the verifying of the identity of the individual may be further based on one or more system identifiers associated with the agent system. For example, the one or more system identifiers may include a phone number, an international mobile equipment identifier, an internet protocol address, and so forth. To further illustrate, the matching of the voice sample of the individual to the voice signature of the individual may be via an MLM implemented by the processing system. In one example, the MLM may be configured to utilize additional inputs, such as the one or more system identifiers noted above. In another example, the verifying may be based upon the outputs of multiple MLMs or other detection models, e.g., a weighted sum or the like may be used to determine whether the call is legitimate.

At step 240, the processing system detects a disclosure of sensitive data by the user via the endpoint device. For instance, in one example, the detecting of the disclosure of the sensitive data by the user may include detecting (e.g., within the call data of the call) that the individual is asking for the sensitive data. Alternatively, or in addition, the detecting of the disclosure of the sensitive data by the user may include detecting, within the call data of the call, speech of the user indicative that the sensitive data is being disclosed. The detecting of the sensitive data may include extracting audio features such as those described above or others, applying the extracted features to a decoder, e.g., an MLM or the like, to identify phonemes, and ultimately spoken characters (e.g., letters or ordinal numbers), words (e.g., including multi-digit numbers), phrases, and so forth. In one example, the output text may be further processed to detect specific keywords, phrases, or other utterances that are indicative of impending disclosure of sensitive information. Alternatively, or in addition, as described above, a trained MLM may be deployed (e.g., implemented by the processing system) that is configured/trained to process new text input data (e.g., in real time/streaming) to detect imminent sensitive data disclosure (in general and/or of one or more specific types). As noted above, the sensitive data may comprise credit card information (e.g., credit card number and/or expiration date, name on card, etc.), a social security number, account information (e.g., an account number (e.g., for a bank account, an account with a utility company, etc.)), a routing number (for a bank account), a wallet identifier (e.g., for a digital wallet or the like), and so forth, a license number (e.g., for a driver's license or other), a passport number, a username (e.g., for an online account; the username can also include a “handle” or the like), an email address, a password, a personal identification number (PIN), a name, street address information (e.g., a full address, or a portion thereof, such as city and state, zip code, etc.), a date of birth, and so forth.

At optional step 245, the processing system may present a notification via the endpoint device of the verifying of the identity of the individual. For instance, the notification may be inserted into an audio stream for the call, e.g., to be audible to user at the endpoint device, and/or to be audible to both the user and the individual. In one example, the notification may further indicate that sensitive data disclosure (e.g., actual or imminent) is detected. In addition, in one example, the notification may further include an instruction as to one or more inputs that the user may provide in order to grant permission to transmit (or block/drop) the sensitive data (e.g., “press or say ‘1’ to proceed, or press or say ‘9’ to block transmission of sensitive data,” or the like).

At optional step 250, the processing system may obtain a user input granting permission to transmit the sensitive data to the agent system, e.g., in response to the presenting of the notification at optional step 245. For instance, the input may be a keyboard, touchpad, or touchscreen input, a verbal input/voice command, a gesture (e.g., where the endpoint device may comprise an augmented reality (AR) device that is capable of capturing video and/or a wearable/biometric device with gyroscope, compass, accelerometer, etc.), or other input.

At step 255, the processing system authorizes the disclosure of the sensitive data via the endpoint device to the agent system, based upon the verifying of the identity of the individual via the matching of the voice sample of the individual to the voice signature of the individual. In one example, the authorizing of the disclosure of the sensitive data may be further based upon the obtaining of the user input granting the permission at optional step 250 to transmit the sensitive data to the agent system. In one example, the authorizing may include enabling the agent system to initiate a web-based and/or app-based dialog in a different communication modality to receive the sensitive data in a different format. For instance, the agent system may transmit a web-based form to the endpoint device of the user, where the user, via the endpoint device may enter the sensitive information into one or more form fields.

In one example, the authorizing of the disclosure of the sensitive data via the endpoint device to the agent system may be via an MLM implemented by the processing system. For example, the MLM may be configured to utilize additional inputs, such as the one or more system identifiers noted above. In this regard, it should be noted that in one example, machine learning may be used at either or both of steps 235 and 255. For instance, a first MLM may be used to verify the identity of the individual via the voice sample to voice signature matching. In one example, the MLM may output a confidence score. Then a second MLM or ensemble of MLMs may be used to make an authorization decision based upon the voice sample to voice signature matching as just one of a plurality of factors that may be used to decide whether the disclosure of the sensitive data should be authorized.

At optional step 260, the processing system may hash the sensitive data to generate a hashed format of the sensitive data. For instance, the sensitive data may be hashed prior to transmission from the endpoint device and/or at an intermediate point in the communication network before transmission to the agent system. In one example, a hash formula/algorithm may be provided to the processing system, e.g., at optional step 210 or otherwise, that may be used for hashing at optional step 260. In one example, the same hash formula/algorithm may be used for both the hashing of the voice sample and the hashing of the sensitive data.

At step 265, the processing system transmits the sensitive data to the agent system, in response to the authorizing of the disclosure of the sensitive data of step 255. In one example, the transmitting of the sensitive data to the agent system may be via the call. In another example, the transmitting of the sensitive data to the agent system may be out-of-band from the call. In one example, the sensitive data may be transmitted in the hashed format, e.g., as generated at optional step 260. In one example, the agent system does not decrypt/un-hash the sensitive data, but may compare the received sensitive data in the hashed format to stored data associated with the user that is also in the hashed format, e.g., to determine that a passcode matches a stored passcode, or the like. For instance, this may enable the agent/agent system to also obtain a point of verification of an identity of the user. In one example, step 265 may be performed so as to prevent the individual from actually hearing the sensitive information. For example, step 265 may include diverting the sensitive information to a portion of the agent system that avoids an agent endpoint device. For instance, this may further protect the user from an agent being able to defraud the user, and may similarly protect the organization from potentially malicious agents harming the reputation of the organization.

Following step 265, the method 200 proceeds to step 295 where the method ends. It should be noted that method 200 may be expanded to include additional steps, or may be modified to replace steps with different steps, to combine steps, to omit steps, to perform steps in a different order, and so forth. For instance, in one example, the processing system may repeat one or more steps of the method 200, such as steps 240-265 for additional sensitive data on the same call, steps 220-265 for a subsequent call between the endpoint device of the user and the same individual, steps 210-265 for the user interacting with a different individual, and so forth. In one example, optional step 245 may precede step 240. In one example, various steps of the method 200 may include processing additional data and/or include additional operations to accommodate a hash-based video signature of the individual, e.g., a signature based on audio and visual features. In one example, the method 200 may be expanded or modified to include steps, functions, and/or operations, or other features described above in connection with the example(s) of FIG. 1, or as described elsewhere herein. Thus, these and other modifications are all contemplated within the scope of the present disclosure.

In addition, although not specifically specified, one or more steps, functions or operations of the method 200 may include a storing, displaying and/or outputting step as required for a particular application. In other words, any data, records, fields, and/or intermediate results discussed in the method 200 can be stored, displayed and/or outputted either on the device executing the method 200, or to another device, as required for a particular application. Furthermore, steps, blocks, functions, or operations in FIG. 2 that recite a determining operation or involve a decision do not necessarily require that both branches of the determining operation be practiced. In other words, one of the branches of the determining operation can be deemed as an optional step. In addition, one or more steps, blocks, functions, or operations of the above described method 200 may comprise optional steps, or can be combined, separated, and/or performed in a different order from that described above, without departing from the examples of the present disclosure.

FIG. 3 depicts a high-level block diagram of a computing device or processing system specifically programmed to perform the functions described herein. For example, any one or more components or devices illustrated in FIG. 1 or described in connection with the example of FIG. 2 may be implemented as the processing system 300. As depicted in FIG. 3, the processing system 300 comprises one or more hardware processor elements 302 (e.g., a microprocessor, a central processing unit (CPU) and the like), a memory 304, (e.g., random access memory (RAM), read only memory (ROM), a disk drive, an optical drive, a magnetic drive, and/or a Universal Serial Bus (USB) drive), a module 305 for transmitting sensitive data from a user endpoint device to an agent system during a call based upon a verification of an identity of an individual associated with the agent system via a matching of a voice sample of the individual obtained via the call to a voice signature of the individual, and various input/output devices 306, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one processor element is shown, it should be noted that the computing device may employ a plurality of processor elements. Furthermore, although only one computing device is shown in the Figure, if the method(s) as discussed above is implemented in a distributed or parallel manner for a particular illustrative example, i.e., the steps of the above method(s) or the entire method(s) are implemented across multiple or parallel computing devices, e.g., a processing system, then the computing device of this Figure is intended to represent each of those multiple computing devices. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 302 can also be configured or programmed to cause other devices to perform one or more operations as discussed above. In other words, the hardware processor 302 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer readable instructions pertaining to the method(s) discussed above can be used to configure a hardware processor to perform the steps, functions and/or operations of the above disclosed method(s). In one example, instructions and data for the present module or process 305 for transmitting sensitive data from a user endpoint device to an agent system during a call based upon a verification of an identity of an individual associated with the agent system via a matching of a voice sample of the individual obtained via the call to a voice signature of the individual (e.g., a software program comprising computer-executable instructions) can be loaded into memory 304 and executed by hardware processor element 302 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 305 for transmitting sensitive data from a user endpoint device to an agent system during a call based upon a verification of an identity of an individual associated with the agent system via a matching of a voice sample of the individual obtained via the call to a voice signature of the individual (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
connecting, by a processing system including at least one processor via a communication network, a call between an endpoint device of a user and an agent system associated with an individual;
obtaining, by the processing system, a voice sample of the individual via the call;
verifying, by the processing system, an identity of the individual, wherein the verifying comprises matching the voice sample of the individual to a voice signature of the individual;
detecting, by the processing system, a disclosure of sensitive data by the user via the endpoint device;
authorizing, by the processing system, the disclosure of the sensitive data via the endpoint device to the agent system, based upon the verifying of the identity of the individual via the matching of the voice sample of the individual to the voice signature of the individual; and
transmitting, by the processing system, the sensitive data to the agent system, in response to the authorizing of the disclosure of the sensitive data.

2. The method of claim 1, wherein the processing system comprises a network-based processing system deployed in the communication network.

3. The method of claim 1, wherein the processing system is a component of the endpoint device.

4. The method of claim 1, wherein the verifying comprises matching a hashed version of the voice sample of the individual to a hashed version of the voice signature of the individual.

5. The method of claim 4, further comprising:
hashing the voice sample of the individual to generate the hashed version of the voice sample.

6. The method of claim 1, wherein the sensitive data is transmitted in a hashed format.

7. The method of claim 6, further comprising:
hashing the sensitive data to generate the sensitive data in the hashed format.

8. The method of claim 1, wherein the voice signature of the individual is obtained via a prior network-based communication between the endpoint device of the user and the agent system.

9. The method of claim 1, wherein the sensitive data comprises at least one of:
credit card information;
a social security number;
account information;
a license number;
a passport number;
a username;
an email address;
a password;
a personal identification number;
a name;
street address information; or
a date of birth.

10. The method of claim 1, wherein the detecting of the disclosure of the sensitive data by the user comprises:
detecting, within call data of the call, that the individual is asking for the sensitive data.

11. The method of claim 1, wherein the detecting of the disclosure of the sensitive data by the user comprises:
detecting, within call data of the call, speech of the user indicative that the sensitive data is being disclosed.

12. The method of claim 1, further comprising:
presenting a notification via the endpoint device of the verifying of the identity of the individual; and
obtaining a user input granting a permission to transmit the sensitive data to the agent system, wherein the authorizing of the disclosure of the sensitive data is further based upon the obtaining of the user input granting the permission to transmit the sensitive data to the agent system.

13. The method of claim 1, wherein the verifying of the identity of the individual is further based on one or more system identifiers associated with the agent system.

14. The method of claim 13, wherein the one or more system identifiers comprise one or more of:
a phone number;
an international mobile equipment identifier; or
an internet protocol address.

15. The method of claim 1, wherein the transmitting of the sensitive data to the agent system is via the call.

16. The method of claim 1, wherein the transmitting of the sensitive data to the agent system is out-of-band from the call.

17. The method of claim 1, wherein the matching of the voice sample of the individual to the voice signature of the individual is via a machine learning model implemented by the processing system.

18. The method of claim 1, wherein the authorizing of the disclosure of the sensitive data via the endpoint device to the agent system is via a machine learning model implemented by the processing system.

19. A non-transitory computer-readable medium storing instructions which, when executed by a processing system including at least one processor, cause the processing system to perform operations, the operations comprising:
connecting, via a communication network, a call between an endpoint device of a user and an agent system associated with an individual;
obtaining a voice sample of the individual via the call;
verifying an identity of the individual, wherein the verifying comprises matching the voice sample of the individual to a voice signature of the individual;
detecting a disclosure of sensitive data by the user via the endpoint device;
authorizing the disclosure of the sensitive data via the endpoint device to the agent system, based upon the verifying of the identity of the individual via the matching of the voice sample of the individual to the voice signature of the individual; and
transmitting the sensitive data to the agent system, in response to the authorizing of the disclosure of the sensitive data.

20. An apparatus comprising:
a processing system including at least one processor; and
a computer-readable storage medium storing instructions which, when executed by the processing system when deployed in a communication network, cause the processing system to perform operations, the operations comprising:
connecting, via a communication network, a call between an endpoint device of a user and an agent system associated with an individual;
obtaining a voice sample of the individual via the call;
verifying an identity of the individual, wherein the verifying comprises matching the voice sample of the individual to a voice signature of the individual;
detecting a disclosure of sensitive data by the user via the endpoint device;
authorizing the disclosure of the sensitive data via the endpoint device to the agent system, based upon the verifying of the identity of the individual via the matching of the voice sample of the individual to the voice signature of the individual; and
transmitting the sensitive data to the agent system.
